(19) United States
(12) Patent Application Publication
(10) Pub. No.: US 2019/0278368 A1
(43) Pub. Date: Sep. 12, 2019

(54) COGNITIVE BLUE LIGHT ADJUSTMENT FOR IMPROVED CIRCADIAN RHYTHM

(71) Applicant: INTERNATIONAL BUSINESS MACHINES CORPORATION, ARMONK, NY (US)

(72) Inventors: JOHN S. WERNER, FISHKILL, NY (US); DIANE M. STAMBONI, POUGHKEEPSIE, NY (US); SARAH WU, KINGSTON, NY (US); SNEHA M. VARGHESE, FISHKILL, NY (US); KAVITA SEHGAL, POUGHKEEPSIE, NY (US); NICHOLAS G. DANYLUK, LONG ISLAND CITY, NY (US)

(21) Appl. No.: 15/914,077

(22) Filed: Mar. 7, 2018

(51) Int. Cl. G06F 3/01; G06F 1/16; G09G 5/02

(52) U.S. Cl. CPC G06F 3/015; G06F 1/163; G09G 2354/00; G09G 2320/0666; G09G 2320/08; G09G 5/02

(57) ABSTRACT

Embodiments include methods, systems and computer program products for adjusting characteristics of light emitted by electronic devices to improve a circadian rhythm of an individual. Aspects include determining the circadian rhythm of the individual based on a plurality of input sources. Aspects also include identifying an active display device being used by the individual. Aspects further include automatically adjusting the characteristics of light emitted by the active display device based on a current stage in the circadian rhythm of the individual.

### BACKGROUND

The present disclosure relates to improving the sleep cycle of an individual by adjusting the light characteristics of electronic devices used by the individual throughout the day.

Blue light sources are becoming increasingly common in today's environment from a variety of technologies including computers, smartphones, televisions, lights, etc. In order to maintain a good sleep balance, it is recommended that people expose themselves to blue light in the morning and afternoon and use a source of red light instead of blue light during the night.

### SUMMARY

In accordance with an embodiment, a method for adjusting characteristics of light emitted by electronic devices to improve a circadian rhythm of an individual is provided. The method includes determining the circadian rhythm of the individual based on a plurality of input sources. The method also includes identifying an active display device being used by the individual. The method further includes automatically adjusting the characteristics of light emitted by the active display device based on a current stage in the circadian rhythm of the individual.

In accordance with another embodiment, a system for adjusting characteristics of light emitted by electronic devices to improve a circadian rhythm of an individual is provided. The system includes a processor in communication with one or more types of memory. The processor is configured to determine the circadian rhythm of the individual based on a plurality of input sources. The processor is also configured to identify an active display device being used by the individual. The processor is further configured to automatically adjust the characteristics of light emitted by the active display device based on a current stage in the circadian rhythm of the individual.

In accordance with a further embodiment, a computer program product for adjusting characteristics of light emitted by electronic devices to improve a circadian rhythm of an individual includes a non-transitory storage medium readable by a processing circuit and storing instructions for execution by the processing circuit for performing a method. The method includes determining the circadian rhythm of the individual based on a plurality of input sources. The method also includes identifying an active display device being used by the individual. The method further includes automatically adjusting the characteristics of light emitted by the active display device based on a current stage in the circadian rhythm of the individual.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of an exemplary system capable of implementing one or more embodiments of the present invention;

FIG. 2 is a flow diagram of a method for adjusting the characteristics of light emitted by electronic devices to improve a circadian rhythm of an individual in accordance with an exemplary embodiment;

FIG. 3 is a flow diagram of another method for adjusting the characteristics of light emitted by electronic devices to improve a circadian rhythm of an individual in accordance with an exemplary embodiment; and

FIG. 4 illustrates a block diagram of a computer system for use in practicing the teachings herein.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, which are related to the adjustment of the characteristics of the light emitted by electronic devices to improve a circadian rhythm of an individual. As used herein the term circadian rhythm refers to a 24-hour internal clock that is running in the background of an individual's brain and cycles between sleepiness and alertness at regular intervals, it is also referred to as a sleep/wake cycle.

In exemplary embodiments, a device with a visual display such as a mobile device is configured to learn a typical circadian rhythm of a user based on a variety of inputs. These inputs can include, but are not limited to, the individual's usage patterns of their mobile device, a calendar of the individual, sensors in the mobile device, usage pattern of a wearable device, and sensors in a wearable device. Based on the circadian rhythm of a user, the mobile device adjusts the characteristic of the light being emitted by the mobile device to improve a user's circadian rhythm. For example, the adjustment can include increasing the amount of blue light that is provided in the morning and afternoon and decreasing the amount of blue light at night. In one embodiment, a camera of a mobile device can be configured to capture images of a user and analyze the user's eyes and face to determine a tiredness level of the user, which may be used to make further adjustments to the characteristic of the light being emitted by the mobile device.

It should be noted that the terms morning, afternoon, and night may vary on an individual user basis depending on the user's daily schedule and are intended to refer to the stage of the user in their circadian rhythm. For example, a particular user may sleep during the day and work the night shift. A reference to the morning for this worker may be 10 pm, afternoon would be around 4 am, and night would be 2 pm. As used herein, blue light is defined as having a wavelength between 450-495 nm, this short wavelength means that blue light is a type of high-energy visible light (defined as having a wavelength between 380 and 500 nm).

Some blue light exposure is essential for good health. Research has shown that high-energy visible light boosts alertness, helps memory and cognitive function which enables better productivity, and elevates mood. Overall, absorbing light during the day, as opposed to night, may make a difference in falling and staying asleep. In addition, extended exposure to the waves transmitted through screen devices during the evening can disrupt circadian rhythm and cause various health effects including a disruption in normal sleep schedules. A lack of blue light may cause the release of melatonin which causes tiredness, may make one less alert and filled with less energy during the day, and could even result in insomnia. When there is not enough light exposure, melatonin levels are maintained homeostatically. Without an increase in melatonin, there is no peak that arouses sleepiness.

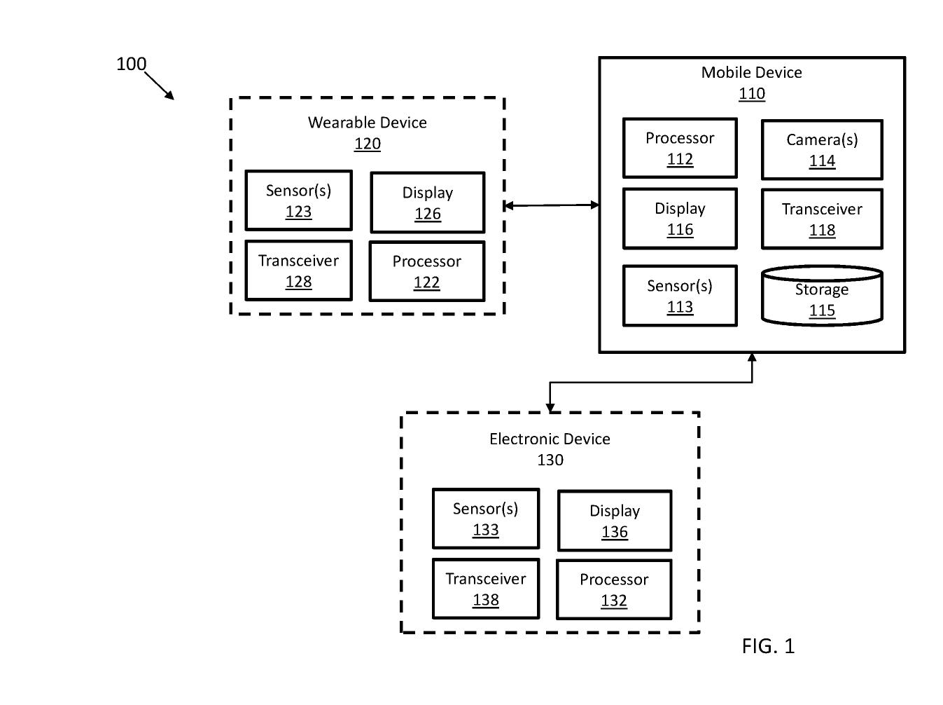

Referring now to FIG. 1, a system 100 for adjusting the characteristics of light emitted by electronic devices to improve a circadian rhythm of an individual is shown. As illustrated the system 100 includes a mobile device 110 that includes a processor 112, a camera 114, a storage device 115, a display 116, a transceiver 118, and one or more sensors 113. In exemplary embodiments, the processor 112 of mobile device 110 uses data received from sensors 113, the camera 114, a wearable device 120, or other sources to determine a circadian rhythm of the user of the mobile device 110. In exemplary embodiments, a user profile, mobile device usage data, sensor data and the determined circadian rhythm of the user are stored in the storage device 115. The circadian rhythm is divided into at least three stages, a waking or early stage after the user awakes from sleeping, a day or middle stage, and an evening or end stages that include the period before the user goes to sleep. Based on a current stage of the determined circadian rhythm of the user of the mobile device 110, the processor 112 of the mobile device 110 automatically adjusts the light characteristics of the display 116 of the mobile device 110. In exemplary embodiments, the sensors 113 can include a GPS sensor for determining the location of the mobile device 110 and an accelerometer for measuring the movement of the mobile device 110.

In exemplary embodiments, once a user's a circadian rhythm is known, the blue light level of the display 116 can be automatically adjusted throughout the day based on the current stage of the circadian rhythm. In one embodiment, the display 116 of the mobile device 110 is configured to have an elevated blue light level early in their day or a morning stage of their circadian rhythm. The display 116 of the mobile device 110 is configured to have a reduced blue light level later in their day or an pre-sleep stage of their circadian rhythm. In addition to adjusting the blue light levels, the red light levels of the display 116 can also be adjusted based on the circadian rhythm. In exemplary embodiments, the amount of red light is increased in the period before the user goes to sleep and decreased in the period after the user wakes up. In various embodiments, the display may be configured to gradually change the characteristics of the light emitted throughout the day or it may apply discrete changes to the characteristics of the light emitted when the stage of the circadian rhythm changes.

In exemplary embodiments, the system 100 can also include a wearable device 120, such as a smartwatch, that includes a processor 122, a display 126, a transceiver 128, and one or more sensors 123. The wearable device 120 is in communication with the mobile device 110 via the transceivers 118/128. The characteristics of the display 126 of the wearable device 120 can also be adjusted based on a current stage of the determined circadian rhythm of the user of the mobile device 110. In addition, the sensors 123 of the wearable device 120 can be used by the mobile device 110 in determining the circadian rhythm of the user of the mobile device 110. In exemplary embodiments, the sensors 123 can include a heart rate sensor for measuring the heart rate of the user and an accelerometer for measuring the movement of the user.

In exemplary embodiments, the system 100 can further include an electronic device 130, such as a television, computer, or tablet, which includes a processor 132, a display 136, a transceiver 138, and one or more sensors 133. The electronic device 130 is in communication with the mobile device 110 via the transceivers 118/138. The characteristics of the display 136 of the electronic device 130 can also be adjusted based on a current stage of the determined circadian rhythm of the user of the mobile device 110. In exemplary embodiments, the sensors 123 can include ambient light sensors that can be used to adjust the brightness of the display 136.

In one example, a first user may wake up at 7 am, work between 9 am-5 pm, and go to bed at 11 pm, but they typically sleep in on the weekends until 10 am and go to bed at 1 am and a second user may work second shift and wakeup at 1 pm, work between 3 pm-1 am, and go to bed at 5 am, but they typically wake earlier on the weekends around 12 pm and go to bed at 3 am. Due to the varying schedules of the first and second user, the blue light should be altered at different times. The first user may be exposed to normal or additional levels of blue light between 7 am and 5 pm, then progressively be exposed to less blue light after 5 pm. The second user may be exposed to normal or additional levels of blue light between 1 pm and 1 am, then progressively be exposed to less blue light after 1 am. At a time such as 10 pm, the first and second users would have noticeably different amounts of blue light levels on their devices.

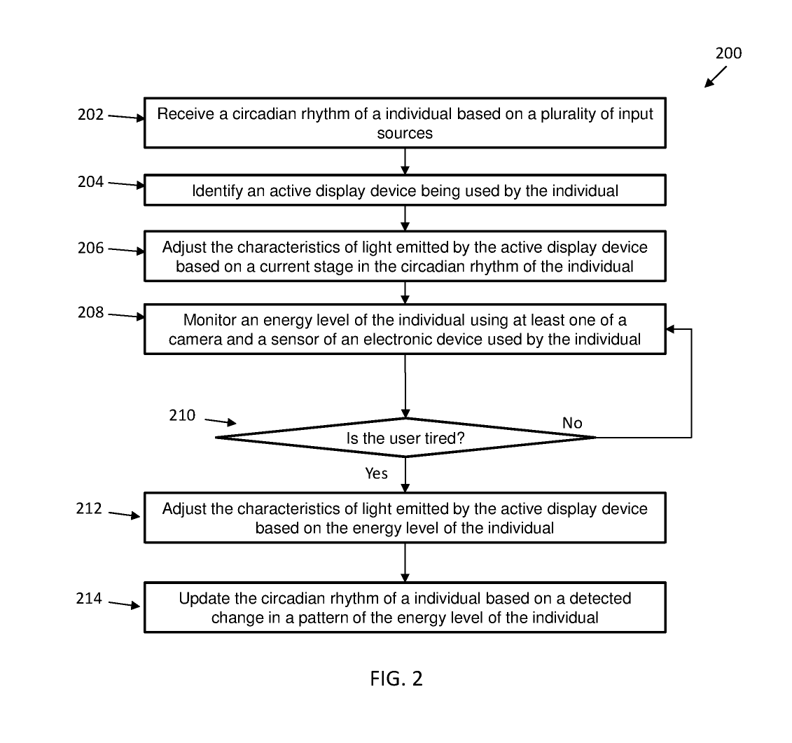

Referring now to FIG. 2, a flow diagram is shown of a method 200 for adjusting the characteristics of light emitted by electronic devices to improve a circadian rhythm of an individual in accordance with an exemplary embodiment. As shown at block 202, the method 200 includes receiving the circadian rhythm of the individual based on a plurality of input sources. In exemplary embodiments, the circadian rhythm of the individual can be received from a storage of the mobile device. During an initial setup the circadian rhythm of the individual can be determined based on input from the user or device data. In one embodiment, a usage pattern of a mobile device can be used as an input source. The input sources can also include one or more of a calendar date, location data, data captured by sensors in a wearable device, and data captured by a camera of a mobile device. Next, as shown at block 204, the method 200 includes identifying an active display device being used by the individual. The active display can be the display of a mobile device, a wearable device, a computer, a television or the like that is being used by the individual. The method 200 also includes automatically adjusting the characteristics of light emitted by the active display device based on a current stage in the circadian rhythm of the individual, as shown at block 206.

Continuing with reference to FIG. 2, the method 200 also includes monitoring an energy level of the individual using at least one of a camera and a sensor of an electronic device used by the individual. In one embodiment, a front-facing camera on the individual's mobile device can periodically take pictures/video of the user while the device is in use. Next, as shown at decision block 210, the method includes determining if the user is tired. The determination if the user is tired can be based on determining if an energy level of the user is below a threshold value. In one embodiment, video recognition software can be configured to analyze the captured images of the user to determine the energy level of the user by recognizing the frequency of blinking, duration of blinks, the velocity of the eyelids, the position of the eyelids, redness in the eyes, nodding of the head, etc. The method 200 also includes adjusting the characteristics of light emitted by the active display device based on the energy level of the individual, as shown at block 212. In exemplary embodiments, the adjustment of the light emitted by the display devices can be based on both the current stage in the circadian rhythm and upon the energy level of the individual. The method 200 also includes updating the circadian rhythm of an individual based on a detected change in a pattern of the energy level of the individual, as shown at block 214.

In one embodiment, feedback from a mobile device camera and other sources of input throughout the day can determine a user's response to personalized blue light variation settings. In addition, the quality and amount of sleep that a user gets can be input by the user via the mobile device or monitored by one or more wearable devices. Based on a determination that the user got a full night's sleep, the blue light level adjustments should be maintained. Based on a determination that the user slept more than the recommended amount, blue light levels may be altered such that less blue light is provided early in the user's day or the lowering of blue light levels may start later in the user's day. Based on a determination that the user is not getting enough sleep, more blue light may be provided early in the user's day or the lowering of blue light levels may start earlier in the user's day. In exemplary embodiments, the blue light level can be continuously adjusted to learn the best levels for an individual user for a better night's sleep and improved circadian rhythm.

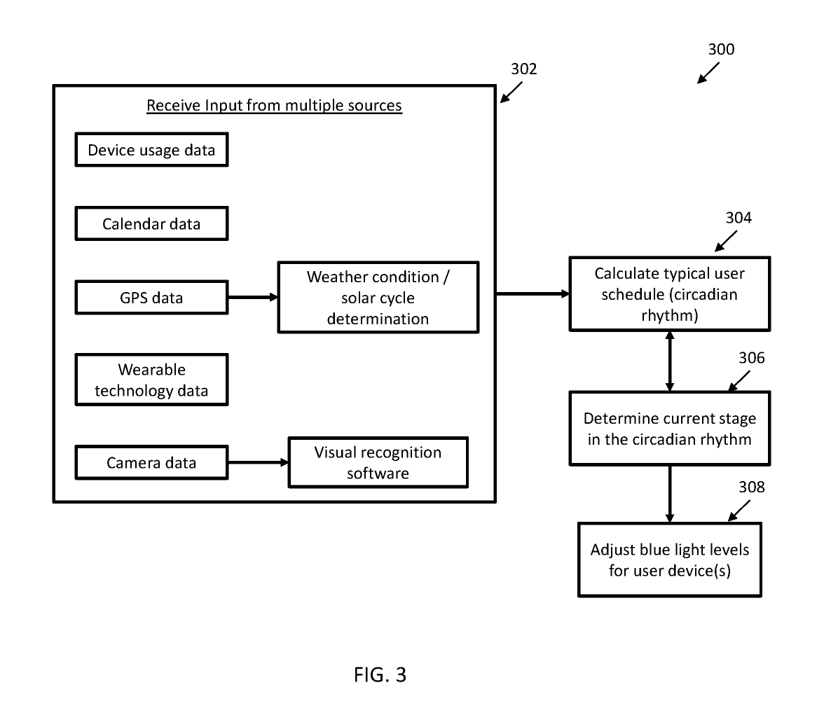

Referring now to FIG. 3, a flow diagram is shown of a method 300 for adjusting the characteristics of light emitted by electronic devices to improve a circadian rhythm of an individual in accordance with an exemplary embodiment. As shown at block 302, the method 300 includes receiving input from multiple sources. The input sources can include, but are not limited to, device usage data such as applications (apps) and/or programs used, duration of use of specific apps and/or programs, total duration of use, time of day that the user uses their devices, alarm application data, etc. In one embodiment, another input source may be the individual's calendar maintained by their mobile device. For example, a user may setup an alarm to help them wake up for an early meeting one day (outside their typical schedule) or a user may be going to a concert at night and stay up later than normal. Many mobile devices will recognize events from text messages and/or emails and automatically add them to the individual's calendar which may help for those users that do not typically add events to their calendar manually.

In exemplary embodiments, another source of input may be the weather conditions and solar cycle data at the individual's current GPS location or a GPS location that they will be visiting that day. The sunlight is a natural source of blue light so the levels of blue light emitted by the individual's devices may be altered depending upon whether or not the sun is out or it is a cloudy or rainy day. The amount of sunlight per day changes on the time of year and can be used as input for blue light level adjustments. A further source of input may be wearable technology that a user has connected to their devices. Smartwatches and activity trackers can help to determine an individual's schedule based on when the user was moving, sleep patterns, heartbeat, etc. In one example, if a user exercises, their body creates energy which may lead to a change in blue light pattern with less of a need of blue light early in their day from their devices while a user that does not exercise may require additional blue light early in their day. Furthermore, a wearable device may be able to determine how much sunlight a user is actually exposed to more accurately than the forecast for their GPS location using the camera and/or sensors disposed within the wearable device (e.g., it may be sunny outside, but the user is working in a dark office).

Continuing with reference to FIG. 3, as shown at block 304, the method 300 includes calculating a typical wake/sleep schedule, or circadian rhythm, for the user based on the multiple input sources 302. Next, as shown at block 306, the method 300 includes determining the current stage of the user in their circadian rhythm. The blue light levels of the displays of the user device are adjusted based on the current stage of the user in their circadian rhythm, as shown at block 308.

Often, electronic devices such as tablets, televisions, computers, etc. are used by multiple different individuals, which have different circadian rhythms. In exemplary embodiments, video recognition software can be used to determine which users are looking at the screen (e.g., a parent may allow their child to play a game on their mobile device). Based on the identity of the user, the device can then make the appropriate adjustments to light characteristics of the display. In one embodiment, blue light levels for the display may default to the lowest level between two or more users if more than one user is viewing the screen.

In some embodiments, the video recognition software can be used to estimate the age of the user(s) and the age of the user can be used as an input source in determining the amount of the variations in blue light levels on the devices (age may also alternatively be provided by the user such that an estimate is not necessary)

In exemplary embodiments, the lighting characteristic adjustment system can be used as a way to minimize the effects of jet lag. For example, a mobile device can receive information for an upcoming flight and use this information as an additional input along with the users typical sleep patterns for adjusting the lighting characteristic of the mobile device display. The flight information can be manually input into the mobile device or it can be extracted by the mobile device from the user's email or calendar automatically. Based on the final destination, flight duration, and time of arrival, blue light levels can be adjusted in the days/weeks leading up to a trip such that a user's sleep pattern can be adjusted to said final destination's time zone. In some embodiments, the plane itself may adjust blue light levels on electronic devices built into the plane (e.g., screen on the back of a headrest or aisle screens, etc.) as well as any devices connected to the planes Wi-Fi to minimize jet lag at the final destination. However, because the users typical sleep patterns are likely not known by the plane/airline, it may request access to user information from their devices within terms and conditions for riding on their plane or using their Wi-Fi services to extract typical sleep patterns and make better blue light adjustments in-flight.

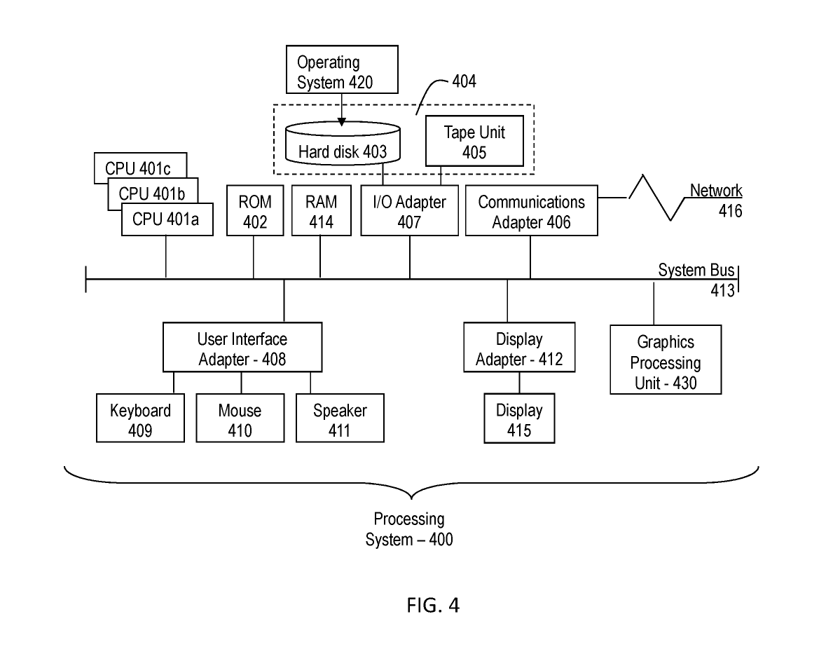

Referring to FIG. 4, there is shown an embodiment of a processing system 400 for implementing the teachings herein. In this embodiment, the system 400 has one or more central processing units (processors) 401a, 401b, 401c, etc. (collectively or generically referred to as processor(s) 401). In one or more embodiments, each processor 401 may include a reduced instruction set computer (RISC) microprocessor. Processors 401 are coupled to system memory 414 and various other components via a system bus 413. Read only memory (ROM) 402 is coupled to the system bus 413 and may include a basic input/output system (BIOS), which controls certain basic functions of system 400.

FIG. 4 further depicts an input/output (I/O) adapter 407 and a network adapter 406 coupled to the system bus 413. I/O adapter 407 may be a small computer system interface (SCSI) adapter that communicates with a hard disk 403 and/or tape storage drive 405 or any other similar component. I/O adapter 407, hard disk 403, and tape storage device 405 are collectively referred to herein as mass storage 404. Operating system 420 for execution on the processing system 400 may be stored in mass storage 404. A network adapter 406 interconnects bus 413 with an outside network 416 enabling data processing system 400 to communicate with other such systems. A screen (e.g., a display monitor) 415 is connected to system bus 413 by display adaptor 412, which may include a graphics adapter to improve the performance of graphics intensive applications and a video controller. In one embodiment, adapters 407, 406, and 412 may be connected to one or more I/O busses that are connected to system bus 413 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 413 via user interface adapter 408 and display adapter 412. A keyboard 409, mouse 410, and speaker 411 all interconnected to bus 413 via user interface adapter 408, which may include, for example, a Super I/O chip integrating multiple device adapters into a single integrated circuit.

In exemplary embodiments, the processing system 400 includes a graphics processing unit 430. Graphics processing unit 430 is a specialized electronic circuit designed to manipulate and alter memory to accelerate the creation of images in a frame buffer intended for output to a display. In general, graphics processing unit 430 is very efficient at manipulating computer graphics and image processing and has a highly parallel structure that makes it more effective than general-purpose CPUs for algorithms where processing of large blocks of data is done in parallel.

Thus, as configured in FIG. 4, the system 400 includes processing capability in the form of processors 401, storage capability including system memory 414 and mass storage 404, input means such as keyboard 409 and mouse 410, and output capability including speaker 411 and display 415. In one embodiment, a portion of system memory 414 and mass storage 404 collectively store an operating system coordinate the functions of the various components shown in FIG. 4.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method for adjusting characteristics of light emitted by electronic devices to improve a circadian rhythm of an individual, the computer implemented method comprises:
determining the circadian rhythm of the individual based on a plurality of input sources, wherein the plurality of input sources includes a calendar of the individual maintained by the electronic device and wherein the calendar includes data regarding events that indicates a deviation from a typical schedule of the individual;
identifying an active display device being used by the individual;
monitoring an energy level of the individual using a camera of an electronic device used by the individual, wherein the energy level of the individual is based at least in part on a redness level of an eye of the user and a frequency that the user blinks; and
automatically adjusting the characteristics of light emitted by the active display device based on a current stage in the circadian rhythm of the individual and upon the energy level of the individual.

2. The computer implemented method of claim 1, wherein the characteristics of light include one of an amount of red light emitted by the active display device and an amount of blue light emitted by the active display device.

3. The computer implemented method of claim 2, wherein the amount of blue light is increased based on the current stage being in a waking stage of the circadian rhythm and wherein the amount of red light is increased based on the current stage being in a pre-sleep stage of the circadian rhythm.

4. The computer implemented method of claim 1, wherein the plurality of input sources, include a typical usage pattern of one or more electronic devices by the individual.

5. (canceled)

6. The computer implemented method of claim 1, wherein the plurality of input sources include a sensor of a wearable electronic device worn by the individual.

7. The computer implemented method of claim 1, wherein the plurality of input sources include a camera of an electronic device used by the individual.

8. (canceled)

9. A computer program product for adjusting characteristics of light emitted by electronic devices to improve a circadian rhythm of an individual, the computer program product comprising:
a storage medium readable by a processing circuit and storing instructions for execution by the processing circuit for performing a method comprising:
determining the circadian rhythm of the individual based on a plurality of input sources, wherein the plurality of input sources includes a calendar of the individual maintained by the electronic device and wherein the calendar includes data regarding events that indicates a deviation from a typical schedule of the individual;
identifying an active display device being used by the individual;
monitoring an energy level of the individual using a camera of an electronic device used by the individual, wherein the energy level of the individual is based at least in part on a redness level of an eye of the user and a frequency that the user blinks; and
automatically adjusting the characteristics of light emitted by the active display device based on a current stage in the circadian rhythm of the individual and upon the energy level of the individual.

10. The computer program product of claim 9, wherein the characteristics of light include one of an amount of red light emitted by the active display device and an amount of blue light emitted by the active display device.

11. The computer program product of claim 10, wherein the amount of blue light is increased based on the current stage being in a waking stage of the circadian rhythm and wherein the amount of red light is increased based on the current stage being in a pre-sleep stage of the circadian rhythm.

12. The computer program product of claim 9, wherein the plurality of input sources include a typical usage pattern of one or more electronic devices by the individual.

13. (canceled)

14. The computer program product of claim 9, wherein the plurality of input sources include a sensor of a wearable electronic device worn by the individual.

15. The computer program product of claim 9, wherein the plurality of input sources include a camera of an electronic device used by the individual.

16. (canceled)

17. A system for adjusting characteristics of light emitted by electronic devices to improve a circadian rhythm of an individual, the system comprising a processor in communication with one or more types of memory, the processor configured to:
determine the circadian rhythm of the individual based on a plurality of input sources, wherein the plurality of input sources includes a calendar of the individual maintained by the electronic device and wherein the calendar includes data regarding events that indicates a deviation from a typical schedule of the individual;
identify an active display device being used by the individual;
monitor an energy level of the individual using a camera of an electronic device used by the individual, wherein the energy level of the individual is based at least in part on a redness level of an eye of the user and a frequency that the user blinks; and
automatically adjust the characteristics of light emitted by the active display device based on a current stage in the circadian rhythm of the individual and upon the energy level of the individual.

18. The system of claim 17, wherein the characteristics of light include one of an amount of red light emitted by the active display device and an amount of blue light emitted by the active display device.

19. The system of claim 18, wherein the amount of blue light is increased based on the current stage being in a waking stage of the circadian rhythm and wherein the amount of red light is increased based on the current stage being in a pre-sleep stage of the circadian rhythm.

20. (canceled)

21. (canceled)
